(19) United States
(12) Patent Application Publication
(10) Pub. No.: US 2006/0195344 A1
(43) Pub. Date: Aug. 31, 2006

(54) Online reservation processing system and method with daylight saving time function

(75) Inventor: Sharon Huang, Shindian City (TW)

Correspondence Address: BIRCH STEWART KOLASCH & BIRCH, PO BOX 747, FALLS CHURCH, VA, 22040-0747, US

(73) Assignee: VIA Technologies, Inc.

(21) Appl. No.: 11/130,212

(22) Filed: May 17, 2005

(30) Foreign Application Priority Data
Feb. 25, 2005 (TW) 094105893

(51) Int. Cl. G06Q 10/00

(52) U.S. Cl. 705/5

(57) ABSTRACT

An online reservation processing system, which has a daylight saving time function, comprises a receiving module and a modulating module. The receiving module receives a set of reserving application data. The set of reserving application data at least comprises date information and time information. The modulating module modulates the time information to produce modulated time information according to daylight-saving-time information and the date information.

### BACKGROUND OF THE INVENTION

1. Field of Invention

The invention relates to a reservation processing system and a reservation processing method, and more particularly to an online reservation processing system and an online reservation processing method.

2. Related Art

The reservation management of the public resources is very complicated. If the public resources are managed in a manual manner on papers, it is difficult to provide the query, register and reservation for the public. In addition, if the reservation time of the public resources is influenced owing to the different time zones and different daylight-saving-time rules, the user tends to unintentionally register the error reservation time.

For example, if the daylight saving time of one hour is effective in place A from April to October, there is the one-hour difference between the local time of place A in the months with effective daylight saving time and the local time of place A in other months without effective daylight saving time. So, there is the one-hour difference between the local times of AM 7 of place A in March and April.

If a person in place A makes a reservation for a meeting room at AM 7 in March and April and the reference time is based on AM 7 of March, he or she has to manually modulate the reservation time in April into AM 8 because the time of AM 7 corresponds to AM 6 of March owing to the daylight saving time. Because the method of modulating the reservation time manually tends to produce error, it is preferred to manage the reservation with an electric reservation system.

Therefore, it is an important subject of the invention to provide an online reservation processing system and an online reservation processing method with a daylight saving time function, which can properly modulate the reservation system so as to adjust the time difference in the system produced by the daylight saving time and to enable the user to correctly register or query the reservation time.

### SUMMARY OF THE INVENTION

In view of the foregoing, the invention is to provide an online reservation processing system and an online reservation processing method capable of modulating the daylight saving time.

To achieve the above, the invention provides an online reservation processing system with a daylight saving time function, which includes a receiving module and a modulating module. The receiving module receives a set of reservation application data, which comprises date information and time information. The modulating module modulates the time information to produce modulated time information according to daylight-saving-time information and the date information.

In addition, the invention also provides an online reservation processing method with a daylight saving time function. The method includes the steps of: receiving a set of reservation application data, which comprises date information and time information; and modulating the time information to produce modulated time information according to daylight-saving-time information and the date information.

As mentioned above, because the online reservation processing system with the daylight saving time function according to the invention has the modulating module, the time difference produced due to the daylight saving time can be modulated in the reservation processing system.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing an online reservation processing system with a daylight saving time function according to a preferred embodiment of the invention;

FIG. 2 is a schematic illustration showing an online reservation processing system with a daylight saving time function according to the preferred embodiment of the invention, wherein the online reservation processing system further includes a database; and

FIG. 3 is a schematic illustration showing an online reservation processing method with a daylight saving time function according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

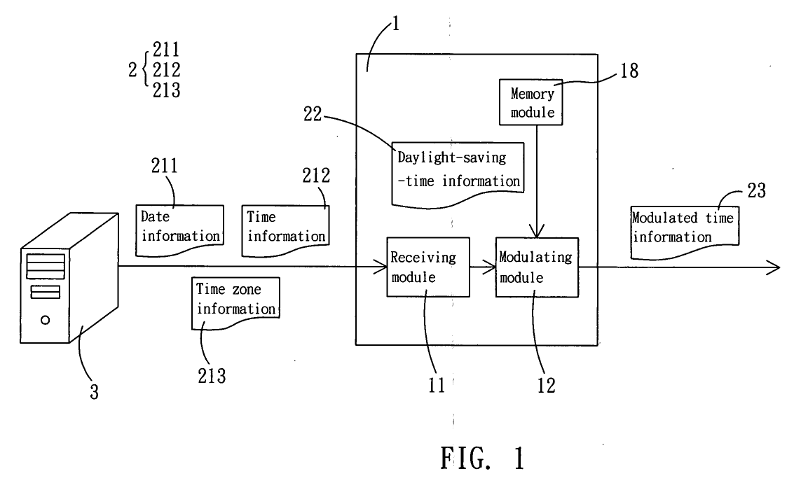

Referring to FIG. 1, an online reservation processing system 1 according to the preferred embodiment of the invention includes a receiving module 11 and a modulating module 12. The receiving module 11 receives a set of reservation application data 21, which includes date information 211 and time information 212. In addition, the modulating module 12 modulates the time information 212 to produce modulated time information 23 according to daylight-saving-time information 22 and the date information 211. The daylight-saving-time information 22 is stored in a memory module 18, and the daylight-saving-time information 22 may be a date table for the implementation of the daylight saving time. The modulating module 12 can query the date table to judge whether or not the date information 211 is within the period of the effective daylight saving time. In addition, the daylight-saving-time information 22 may also be a rule of the implementation of the daylight saving time (e.g., the dates from April to October), and the daylight-saving-time information may be created according to the daylight-saving-time rule issued by various local governments. Furthermore, the modulating module 12 can judge whether or not the date information 211 falls within the period of the daylight saving time according to this rule.

In this embodiment, the online reservation processing system 1 can be used in the reservation management for a meeting room. For example, the daylight saving time is effective in place A from April to October, and the user in place A receives the reservation application data 21 from a client computer 3 in March. The date information 211 and the time information 212 of the reservation application data 21 are “April 6” and “AM 7 to AM 8”, respectively. The receiving module 11 receives the reservation application data 21. The modulating module 12 judges that the date information 211 “April 6” is within the period of the effective daylight saving time according to the daylight-saving-time information 22 and the date information 211. So, the time of “AM 8” on April 6 corresponds to the time of “AM 7” in March, and the modulating module 12 modulates the time information 212 “AM 7 to AM 8” to produce a modulated time information 23 “AM 8 to AM 9”.

Thus, it is assumed that the daylight saving time is never effective throughout the year in place B (e.g., Taiwan), and the users in places A and B make, in March, a reservation of meeting through a network meeting room at the local time of place B from PM 5 to PM 6 on April 6 (the time of place A is from AM 7 to AM 8 in March or from AM 8 to AM 9 in April). If the date information and time information reserved by the user in place A in March are “April 6” and “AM 7 to AM 8”, respectively, the reservation time can be correctly modulated into “AM 8 to AM 9” after the modulation of the online reservation processing system.

In addition, the reservation application data 21 may further include time zone information 213. In this embodiment, the time zone information 213 includes the time difference data between places A and B, and the time difference data is “10-hours time difference between places A and B”. At this time, if the user in place B reserves a meeting room in place A according to the local time of place B of “PM 5 to PM 6 on April 6”, the modulating module 12 modulates the time information 212 “PM 5 to PM 6” to produce the modulated time information “AM 8 to AM 9” according to the time zone information 213, the daylight-saving-time information 22 and the date information 211 “April 6”.

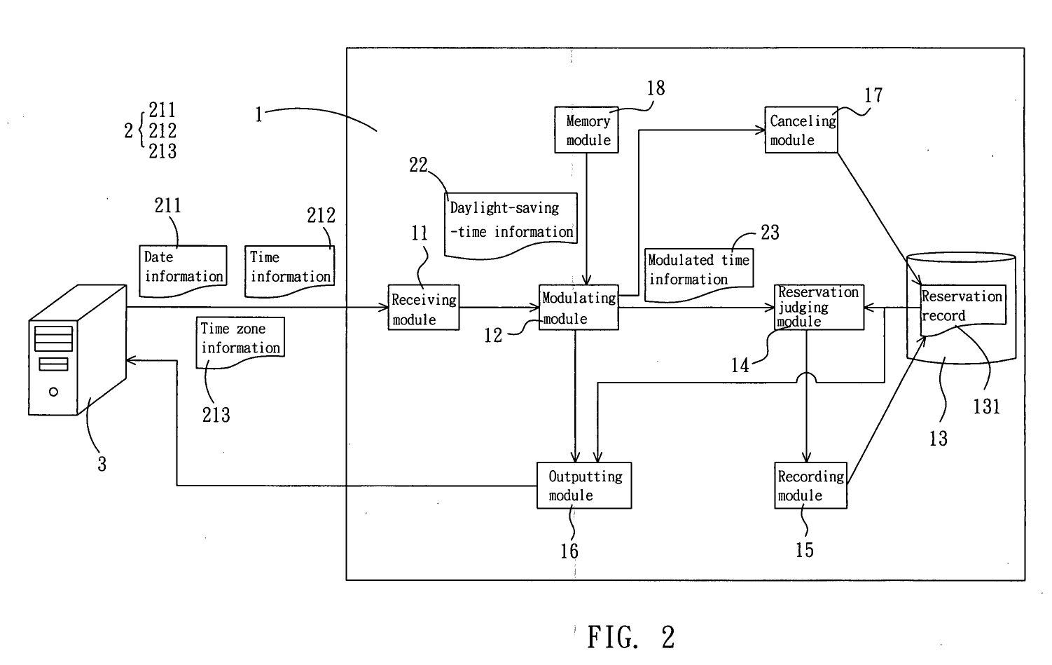

Referring to FIG. 2, the online reservation processing system 1 further includes a database 13, a reservation judging module 14, a recording module 15, an outputting module 16, a canceling module 17 and a memory module 18. The database 13 stores a plurality of reservation records 131. The reservation judging module 14 judges whether or not the reservation application data 21 and the modulated time information 23 overlap with the reservation records 131. When the reservation application data 21 does not overlap with the reservation records 131, the recording module 15 adds a new reservation record to the database 13. The new reservation record includes the reservation application data 21 and the modulated time information 23. For example, if the reservation application data 21 is “AM 7 to AM 8 on April 6” and the modulated time information 23 is “AM 8 to AM 9”, then the reservation judging module 14 judges whether or not the reservation records 131 overlap with “AM 8 to AM 9 on April 6”. If no overlap occurs, the recording module 15 adds a new reservation record “AM 8 to AM 9 on April 6” to the database 13.

The outputting module 16 can output the reservation application data 21, the modulated time information 23 and the reservation records 131 onto a display such that the user can get the reservation result. In addition, the online reservation processing system 1 can query the associated reservation records 131 according to the reservation application data 21, and output the reservation application data 21 and the reservation records 131 to the client computer 3 through the outputting module 16 such that the user can query the reservation condition. Furthermore, the canceling module 17 can select one of the reservation records 131 from the database 13 according to the reservation application data 21, and mark the selected reservation record 131 with a canceling reservation flag (not shown in the FIG. 2) to represent that the reservation record is invalid and the reserved time is free for the reservations of others.

The online reservation processing system of this embodiment can deal with the reservation registers crossing several time zones such that the users can register reservations of various resources such as the computer workstations or cars and lodgment for business in different time zones.

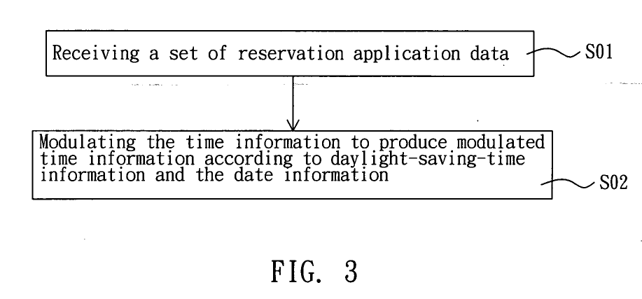

Referring to FIG. 3, the online reservation processing method with the daylight saving time function according to the preferred embodiment of the invention includes the following steps S01 and S02.

In step S01, a set of reservation application data is received, wherein the reservation application data includes date information and time information.

In step S02, the time information is modulated to produce modulated time information according to daylight-saving-time information and the date information.

Because the online reservation processing method with the daylight saving time function of this embodiment can be used in the online reservation processing systems as shown in FIGS. 1 and 2, the detailed descriptions thereof are the same as the above-mentioned embodiments and will be omitted.

In summary, because the online reservation processing system with the daylight saving time function according to the invention has the modulating module, the time difference produced due to the daylight saving time in the reservation processing system can be modulated.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An online reservation processing system with a daylight saving time function, comprising:
a receiving module, which receives a set of reservation application data, wherein the set of reservation application data comprises date information and time information; and
a modulating module, which modulates the time information to produce modulated time information according to daylight-saving-time information and the date information.

2. The online reservation processing system according to claim 1, further comprising:
a database, which stores a plurality of reservation records.

3. The online reservation processing system according to claim 2, further comprising:
a recording module, which adds a new reservation record to the database, wherein the new reservation record comprises the set of reservation application data and the modulated time information.

4. The online reservation processing system according to claim 3, further comprising:
a reservation judging module, which judges whether or not the set of reservation application data overlaps with the reservation records, wherein when the set of reservation application data does not overlap with the reservation records, the recording module adds the new reservation record to the database, and the new reservation record comprises the set of reservation application data and the modulated time information.

5. The online reservation processing system according to claim 2, further comprising:
an outputting module, which outputs at least one of the reservation application data, the modulated time information and the reservation records.

6. The online reservation processing system according to claim 2, further comprising:
a canceling module, which selects one of the reservation records from the database according to the reservation application data, and marks the selected reservation record with a canceling reservation flag.

7. The online reservation processing system according to claim 1, wherein the set of reservation application data further comprises time zone information, and the modulating module modulates the time information to produce the modulated time information according to the time zone information, the daylight-saving-time information and the date information.

8. The online reservation processing system according to claim 1, wherein the daylight-saving-time information is created according to daylight-saving-time rules issued by local governments.

9. An online reservation processing method with a daylight saving time function, comprising:
receiving a set of reservation application data, wherein the set of reservation application data comprises date information and time information; and
modulating the time information to produce modulated time information according to daylight-saving-time information and the date information.

10. The method according to claim 9, further comprising:
storing a plurality of reservation records into a database.

11. The method according to claim 10, further comprising:
storing the set of reservation application data and the modulated time information into the database.

12. The method according to claim 11, further comprising:
judging whether or not the set of reservation application data overlaps with each of the reservation records; and
adding a new reservation record to the database when the set of reservation application data does not overlap with the reservation records, wherein the new reservation record comprises the set of reservation application data and the modulated time information.

13. The method according to claim 10, further comprising:
outputting at least one of the reservation application data, the modulated time information and the reservation records.

14. The method according to claim 10, further comprising:
selecting one of the reservation records from the database according to the reservation application data; and
marking the selected reservation record with a canceling reservation flag.

15. The method according to claim 9, further comprising:
modulating the time information to produce the modulated time information according to a time zone information, the daylight-saving-time information and the date information of the set of reservation application data.

16. The method according to claim 9, wherein the daylight-saving-time information is created according to daylight-saving-time rules issued by local governments.
